(19) United States
(12) Patent Application Publication
(10) Pub. No.: US 2026/0214339 A1
(43) Pub. Date: Jul. 23, 2026

(54) CONTROL APPARATUS, CONTROL METHOD, AND STORAGE MEDIUM

(71) Applicant: CANON KABUSHIKI KAISHA, Tokyo (JP)

(72) Inventor: TAKUYA TOYODA, Tokyo (JP)

(21) Appl. No.: 19/444,924

(22) Filed: Jan. 9, 2026

(30) Foreign Application Priority Data
Jan. 21, 2025 (JP) 2025-008719

(51) Int. Cl. H04N 23/695; G06T 7/20; H04N 23/611

(52) U.S. Cl. CPC H04N 23/695; G06T 7/20; H04N 23/611; G06T 2207/30201

(57) ABSTRACT

A control apparatus detects a plurality of objects from a video image captured by an imaging device, determines an imaging range of the imaging device based on history information about objects set as tracking targets to image all the objects set as the tracking targets out of the plurality of objects, and controls the imaging device so that the imaging range is set to the determined imaging range.

### BACKGROUND

### Field of the Technology

The present disclosure relates to a control apparatus, a control method, and a storage medium.

### Description of the Related Art

In recent years, there has been a growing demand for automatically imaging a scene including an object in motion using a remote camera. Among techniques of performing such automatic imaging, there is a known technique in which the field-of-view is adjusted through control of pan, tilt, and zoom (hereinafter referred to as PTZ) to the motion of a tracking target, so that the tracking target is kept within the field of view. In this case, for a plurality of tracking targets, the PTZ control is generally performed in such a manner that the center of gravity of all the tracking targets is positioned at the center of a screen to keep all the tracking targets within the screen. For example, when one of the tracking targets moves toward an edge of the screen, a wide-angle zoom control is performed to prevent the target from going out of view. When the tracking targets move toward the center of the screen and gather together, a telephoto zoom control is performed. Japanese Patent Laid-Open No. 2022-60900 describes a technique of performing PTZ control to keep an imaging target in a screen based on the positions, the sizes, the occlusion rate, and the moving speeds of objects detected in video images captured by a plurality of cameras, and orientation information about the cameras.

However, in the technique described in Japanese Patent Laid-Open No. 2022-60900, when a tracking target in a screen moves outside the screen, a wide-angle zoom control is inevitably performed. As a result, another tracking target that was displayed as being small may become smaller than a detectable size, which will not be detected, being excluded from the tracking targets. For example, there are cases where a tracking target in the screen intentionally moves outside the screen to avoid being imaged, so that an appropriate field-of-view operation cannot be performed based on the condition.

### SUMMARY

In view of the above-described issue, the present disclosure is directed to enabling an appropriate field-of-view operation to be performed based on the condition when a plurality of tracking targets are automatically tracked.

According to an aspect of the present disclosure, a control apparatus detects a plurality of objects from a video image captured by an imaging device, determines an imaging range of the imaging device based on history information about objects set as tracking targets to image all the objects set as the tracking targets out of the plurality of objects, and controls the imaging device so that the imaging range is set to the determined imaging range.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of the functional configuration of an automatic imaging system according to a first embodiment.

FIG. 2 is a flowchart illustrating an example of a processing procedure for performing a field-of-view operation by an imaging control apparatus according to the first embodiment.

FIG. 3 is a diagram for describing a situation in which a change in field-of-view operation information is determined to be unnecessary.

FIG. 4 is a diagram for describing a situation in which a change in the field-of-view operation information is determined to be necessary.

FIG. 5 is a diagram for describing a field-of-view when a change in the field-of-view operation information is determined to be unnecessary.

FIG. 6 is a diagram for describing a result of recalculating the field-of-view operation information after a change in the field-of-view operation information is determined to be necessary.

FIG. 7 is a block diagram illustrating an example of the functional configuration of an automatic imaging system according to a second embodiment.

FIG. 8 is a flowchart illustrating an example of a processing procedure for performing a field-of-view operation by an imaging control apparatus according to the second embodiment.

FIG. 9 is a diagram for describing a state in which a change in the field-of-view operation information is determined to be unnecessary and a zoom magnification is maintained.

FIG. 10 is a diagram for describing a method for recalculating the field-of-view operation information after a predetermined time has elapsed since the start of holding information about the zoom magnification.

FIG. 11 is a diagram for describing an example in which a new tracking target appears on a screen while the information about the zoom magnification is held.

FIG. 12 is a block diagram illustrating an example of the hardware configuration of the imaging control apparatus.

### DESCRIPTION OF THE EMBODIMENTS

In the following description, some embodiments of the present disclosure will be described with reference to the drawings. The present disclosure is not limited to the embodiments described below, and various forms within the range that does not depart from the gist of this present disclosure are included in the present disclosure. Further, each of the embodiments described below merely exemplifies one embodiment of the present disclosure, and each of the embodiments can also be combined as appropriate.

### First Embodiment

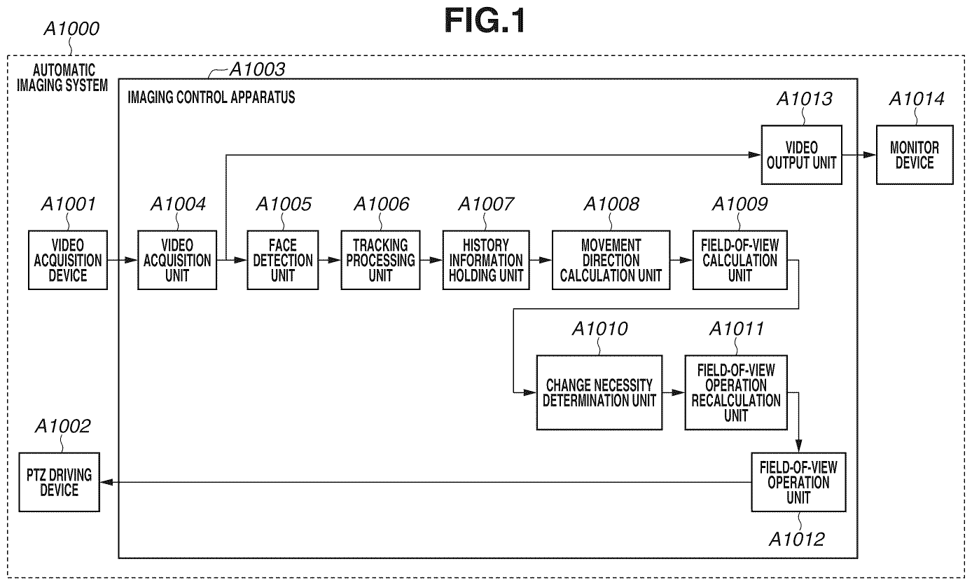

An example will be described of a configuration of an automatic imaging system according to a first embodiment with reference to FIG. 1. FIG. 1 is a block diagram illustrating an example of the functional configuration of the automatic imaging system including an imaging control apparatus according to the present embodiment.

An automatic imaging system A1000 performs tracking processing based on video data acquired from a video acquisition device A1001 to perform a field-of-view operation using a pan, tilt, and zoom (PTZ) driving device A1002 to prevent tracking targets from being outside the field of view. At that time, if the imaging range is expanded by a wide-angle zoom control and a target below a detectable size that is undetectable exists, an appropriate field-of-view operation is performed based on a condition of the tracking target in the screen. Then, an imaging result is displayed on a monitor device A1014.

The automatic imaging system A1000 includes the video acquisition device A1001, the PTZ driving device A1002, an imaging control apparatus A1003, and the monitor device A1014. The imaging control apparatus A1003 is connected to the video acquisition device A1001 and the PTZ driving device A1002 via a network. Further, the imaging control apparatus A1003 is connected to the monitor device A1014 via a video interface.

The video acquisition device A1001, which includes a camera, captures images of the surroundings to generate video data. The video acquisition device A1001 outputs the generated video data to the imaging control apparatus A1003.

The PTZ driving device A1002, which includes a driving device, such as motors for performing pan, tilt, and zoom (PTZ) control, changes the field-of-view (or the imaging range) of the camera of the video acquisition device A1001. The PTZ driving device A1002 performs PTZ driving based on PTZ control instructions input from a field-of-view operation unit A1012 of the imaging control apparatus A1003.

The imaging control apparatus A1003 performs the tracking processing based on a plurality of pieces of face information detected using the input video data. At this time, the imaging control apparatus A1003 determines whether a tracking target is below the detectable size, which is undetectable, and is excluded from the tracking targets due to a field-of-view operation calculated to keep the tracking targets within the field-of-view. When a tracking target is excluded from the tracking targets, an appropriate field-of-view operation is performed based on the direction in which the tracking target moves in the screen. The imaging control apparatus A1003 includes a video acquisition unit A1004, a face detection unit A1005, a tracking processing unit A1006, a history information holding unit A1007, a movement direction calculation unit A1008, a field-of-view operation calculation unit A1009, a change necessity determination unit A1010, and a field-of-view operation recalculation unit A1011. Further, the imaging control apparatus A1003 includes a field-of-view operation unit A1012 and a video output unit A1013.

The video acquisition unit A1004 outputs the video data acquired from the video acquisition device A1001 to the face detection unit A1005 and the video output unit A1013.

The face detection unit A1005 performs processing for detecting a face in the video image from the video data input from the video acquisition unit A1004. The face detection processing may use any method capable of detecting a face, such as a template matching technique or a semantic segmentation technique. The template matching technique and the semantic segmentation technique are known techniques, and detailed descriptions thereof will be omitted. The face detection unit A1005 outputs to the tracking processing unit A1006 face information including coordinate information about the face detected from the video data.

The tracking processing unit A1006 performs the tracking processing based on a plurality of pieces of face information input from the face detection unit A1005. The tracking processing unit A1006 selects a tracking target to start the tracking processing when the tracking processing is not being performed. The tracking processing unit A1006 inputs the plurality of pieces of detected face information to perform the tracking processing when the tracking processing is being performed.

As the method of selecting a tracking target, all people appearing on the screen can be selected or a tracking target can be selected based on preset region information. The region information here refers to information about a region in a real space in which a tracking target is tracked. For example, if a blackboard exists in the real space, the tracking processing is not performed on a region corresponding to the blackboard. In other words, people outside the region corresponding to the blackboard are selected as the tracking targets. Further, the imaging control apparatus A1003 may be configured to select at least one or more targets based on a user's input. The imaging control apparatus A1003 may perform the tracking processing to track as many people as the number of people entered by the user. In other words, when face information about ten people is input from the face detection unit A1005 with the imaging control apparatus A1003 set to track six people by a user's input, the tracking processing is performed to track six people out of the ten people. As for a method of selecting the six people, when a person is selected as the target by a user's input, five people who are at the shortest distances from the coordinate information about the target's faces are selected. The tracking processing may use any method capable of associating the position and the size information about a tracking target in the current frame based on the position and the size information about the selected tracking target in the preceding frame and the input face information. For example, a method may be used in which the position of a tracking target is determined by associating a predicted position based on the movement history of the tracking target with the detected position of the face. Then, the tracking processing unit A1006 outputs a tracking processing result to the history information holding unit A1007.

The history information holding unit A1007 holds the tracking processing result input from the tracking processing unit A1006 as history information, and outputs the history information to the movement direction calculation unit A1008.

The movement direction calculation unit A1008 calculates the movement direction of each tracking target based on the history information about the tracking processing result input from the history information holding unit A1007. The movement direction can be calculated using any method that calculates the movement direction based on the coordinate information about each tracking target in the history information. For example, the vector of the movement direction may be calculated based on coordinates of two points, or an upward, downward, leftward, or rightward movement direction in a plane may be simply calculated. Further, the movement direction may be considered to be absent when a difference in the history information is smaller than a predetermined value. Then, the movement direction calculation unit A1008 outputs the calculated movement direction of each tracking target and the tracking processing result to the field-of-view operation calculation unit A1009.

The field-of-view operation calculation unit A1009 calculates field-of-view operation information based on the tracking processing result of each tracking target input from the movement direction calculation unit A1008. The field-of-view operation information can be calculated using any method capable of keeping the tracking target within the field-of-view, and a direction and a speed in the field-of-view operation can be calculated or a position and a zoom magnification in the field-of-view operation can be calculated as the field-of-view operation information. Further, when the field-of-view operation information is calculated, coordinate information about all the tracking targets is used. Then, the zoom magnification can be calculated in such a manner that the center of gravity of all the tracking targets is positioned at the center of the captured image and the circumscribed rectangles of all the tracking targets account for predetermined percentages of the captured image. Alternatively, the field-of-view operation information can be calculated based on the coordinate information about all the tracking targets and preset composition information. The composition information in the present embodiment is parameters, such as the layout, the sizes, the number, and the positional relationship of the circumscribed rectangles in the captured image. For example, in a case where the composition information is preset so as to arrange a subject on the left of a captured image, the field-of-view operation calculation unit A1009 calculates the field-of-view operation information in such a manner that at least one of the tracking targets is arranged on the left based on the coordinate information about the tracking target and the composition information. The field-of-view operation calculation unit A1009 outputs the calculated field-of-view operation information and the tracking processing result to the change necessity determination unit A1010.

The change necessity determination unit A1010 determines whether a change in the field-of-view operation information is necessary based on the field-of-view operation information and the tracking processing result input from the field-of-view operation calculation unit A1009. This determination is made when a tracking target below the detectable size exists due to the wide-angle zoom operation, and whether a change is necessary is determined based on a movement direction of the tracking target in the screen. The detectable size is a value specific to a detector that varies depending on the input video size. If the detectable size can be acquired from the detector, this value may be used; otherwise, an experimentally calculated value may be used.

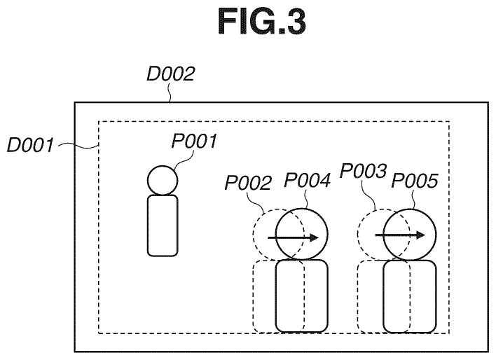

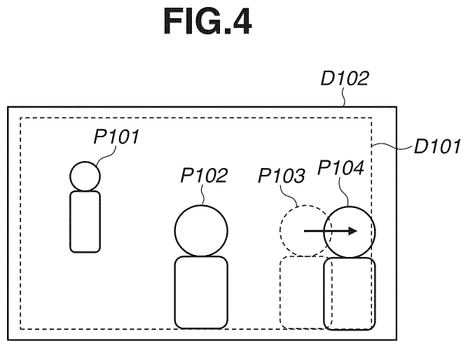

In the following description, a method will be described for determining whether a change in field-of-view operation information is necessary with reference to FIGS. 3 and 4. FIG. 3 is a diagram for describing a condition in which a change in field-of-view operation information is determined to be unnecessary, and FIG. 4 is a diagram for describing a condition in which a change in field-of-view operation information is determined to be necessary. FIG. 3 illustrates a current field of view D001 and a field of view D002 calculated from the tracking processing result. Further, FIG. 3 illustrates human bodies P001, P002, P003, P004, and P005. The human bodies P004 and P005 indicate destinations to which the human bodies P002 and P003 move from the preceding frame, respectively, and both the human bodies P004 and P005 indicate that the human bodies P002 and P003 have moved rightward in the screen.

It is on the assumption that the human body P001 does not move from the preceding frame, and appears at the detectable smallest size in the screen in the current field of view D001.

In the example illustrated in FIG. 3, the field of view D002 is calculated based on the tracking processing results of the human bodies P001, P004, and P005 in the current frame. The field of view D002 is a field of view obtained by the wide-angle zoom operation being applied to the field of view D001, and the human body P001 is below the detectable smallest size, which is undetectable in the field of view D002. However, while the human body P001 does not move, the human bodies P004 and P005 move rightward in the screen, which means that the number of human bodies that have moved in the direction which follows the wide-angle zoom operation is half or more of all the human bodies. Thus, it is considered to be desirable to perform a field-of-view operation including the wide-angle zoom operation, and a change in the field-of-view operation information is determined to be unnecessary under the condition illustrated in FIG. 3.

On the other hand, the example illustrated in FIG. 4 represents a current field of view D101 and a field of view D102 calculated from the tracking processing results. Further, FIG. 4 illustrates human bodies P101, P102, P103, and P104. The human body P104 represents a destination to which the human body P103 moves from the preceding frame, and indicates that the human body P103 has moved rightward in the screen. On the other hand, the human bodies P101 and P102 are assumed not to move from the preceding frame. Further, it is assumed that the human body P101 appears at the detectable smallest size in the current field of view D101.

In the example illustrated in FIG. 4, the field of view D102 is calculated based on the tracking processing results of the human bodies P101, P102, and P104 in the current frame. The field of view D102 is a field of view obtained by the wide-angle zoom operation being applied to the field of view D101, and the human body P101 is below the detectable smallest size, which is undetectable in the field of view D102. At this time, the human bodies P101 and P102 do not move and the human body P104 has moved in the rightward direction which follows the wide-angle zoom operation, which means that the number of human bodies that have moved in this direction is less than half of all the human bodies. Thus, it is considered to be desirable for a field-of-view operation to be performed in such a manner that the human bodies that do not move in the screen can be kept in the screen without performing the wide-angle zoom operation, and a change in the field-of-view operation information is determined to be necessary under the condition illustrated in FIG. 4.

The change necessity determination unit A1010 outputs to the field-of-view operation recalculation unit A1011 a result of determination as to whether a change in the field-of-view operation information is necessary and the tracking processing result of a target subject to recalculation. A threshold for whether a change in the field-of-view operation information is necessary is set to half of all the human bodies, but is not limited thereto. A threshold can be changed based on the condition.

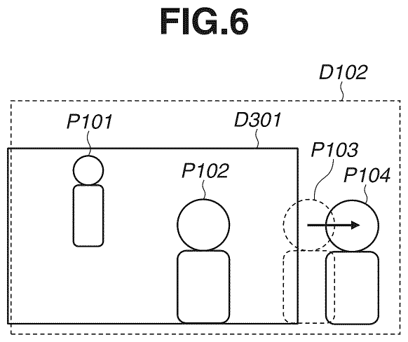

If a change in the field-of-view operation information is determined to be necessary by the change necessity determination unit A1010, the field-of-view operation recalculation unit A1011 recalculates the field-of-view operation information using the tracking processing result of the target subject to recalculation. FIG. 6 is a diagram for describing a result of recalculating the field-of-view operation information after a change in the field-of-view operation information is determined to be necessary in the example illustrated in FIG. 4. As illustrated in FIG. 6, the field-of-view operation information is recalculated using the tracking processing results of the human bodies P101 and P102 that do not move in the screen, and the field of view is changed from the field of view D102 to a field of view D301.

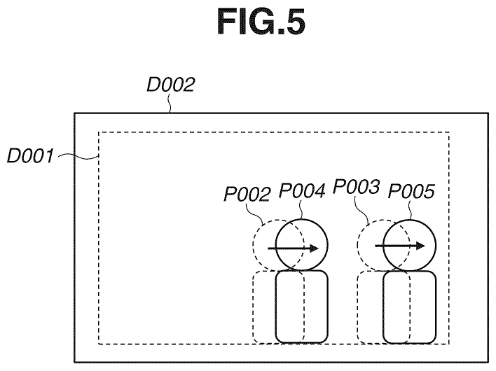

On the other hand, if a change in the field-of-view operation information is determined to be unnecessary by the change necessity determination unit A1010, the field-of-view operation information calculated by the field-of-view operation calculation unit A1009 is used without being changed as illustrated in FIG. 5. The field-of-view operation recalculation unit A1011 outputs the field-of-view operation information to the field-of-view operation unit A1012.

The field-of-view operation unit A1012 generates a PTZ control instruction based on the field-of-view operation information input from the field-of-view operation recalculation unit A1011. The field-of-view operation unit A1012 then outputs the generated PTZ control instruction to the PTZ driving device A1002.

The video output unit A1013 outputs the video data input from the video acquisition unit A1004 to the monitor device A1014.

The monitor device A1014 displays the video data input from the video output unit A1013.

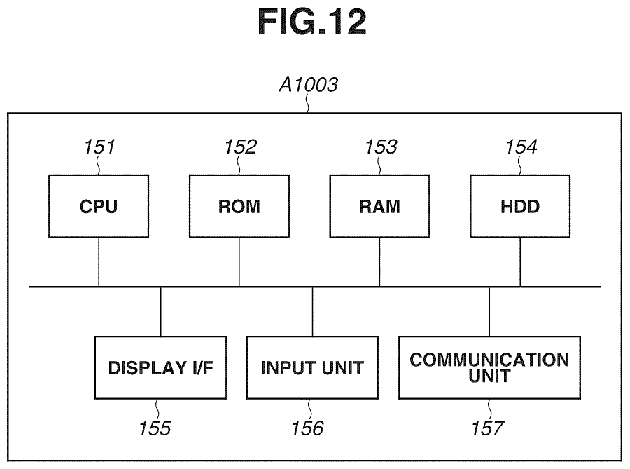

FIG. 12 is a block diagram illustrating an example of a hardware configuration of the imaging control apparatus A1003 according to the present embodiment. The imaging control apparatus A1003 includes a central processing unit (CPU) 151, a read only memory (ROM) 152, a random-access memory (RAM) 153, a hard disk drive (HDD) 154, a display interface (I/F) 155, an input unit 156, and a communication unit 157.

The CPU 151 reads control programs stored in the ROM 152 to perform various kinds of processing. The RAM 153 is used as a temporary storage area, such as a main memory and a working area of the CPU 151. The HDD 154 stores various kinds of data, various kinds of programs, and the like. The display I/F 155 is used for outputting video data and various kinds of information to the monitor device A1014. The input unit 156, which includes a keyboard and a mouse, receives various kinds of operations input by the user.

The communication unit 157 performs communication processing with an external device via a network. Specifically, the communication unit 157 includes terminals in compliance with communication standards, such as Universal Serial Bus (USB), a local area network (LAN), and a wireless LAN, or image communication standards, such as High-Definition Multimedia Interface (HDMI®), and the processing circuitry.

The above-described functions and processing of the imaging control apparatus A1003 are performed by the CPU 151 reading a program stored in the ROM 152 or the HDD 154 to execute the program. Further, as another example, the CPU 151 may read a program stored in a recording medium, such as a Secure Digital (SD) card, instead of the ROM 152 or the like.

Further, in the present embodiment, in the imaging control apparatus A1003, each operation illustrated in a flowchart described below is performed by a single processor (the CPU 151) using a single memory (the ROM 152), but a different form may be implemented. For example, a plurality of processors, a plurality of RAMs and ROMs, and a storage coordinate with one another to perform each operation illustrated in the flowchart described below. Further, the imaging control apparatus A1003 may also be configured to perform a part of the processing using a hardware circuit.

Further, the functions and the processing of the imaging control apparatus A1003 may be implemented using a processor different from the CPU. For example, the imaging control apparatus A1003 may use a graphics processing unit (GPU) instead of the CPU 151, or may include both a CPU and a GPU.

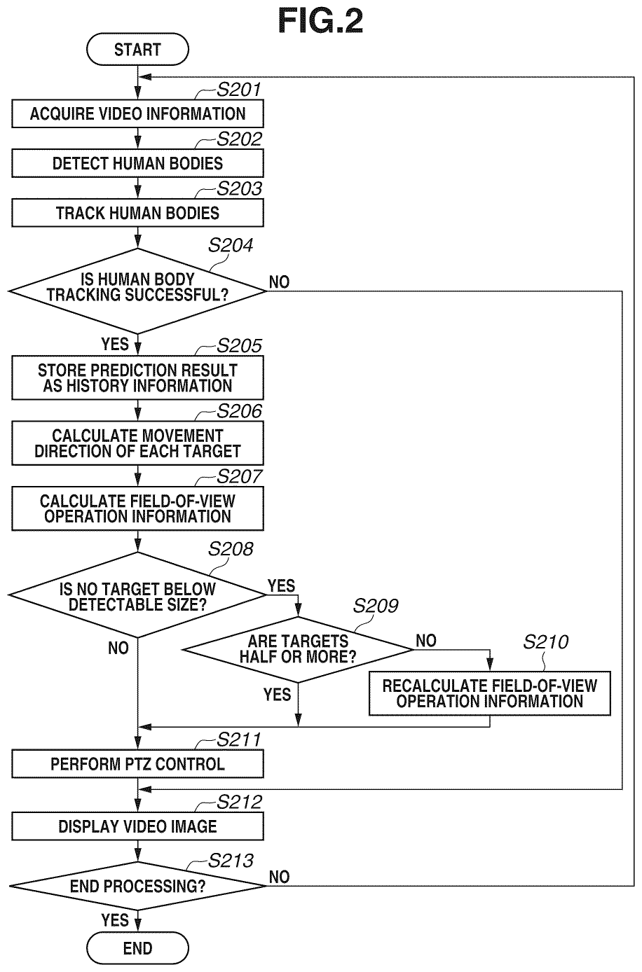

FIG. 2 is a flowchart illustrating an example of a processing procedure for performing the field-of-view operation by the imaging control apparatus A1003 in the automatic imaging system A1000. Each operation in FIG. 2 is performed by the CPU 151 loading a program stored in the ROM 152 into the RAM 153 to execute the program. The processing illustrated in FIG. 2 starts upon the automatic imaging system A1000 being started by the input unit 156 via a user's operation.

In step S201, the video acquisition unit A1004 acquires video data from the video acquisition device A1001, and outputs the video data to the face detection unit A1005 and the video output unit A1013. The processing then proceeds to step S202.

In step S202, the face detection unit A1005 performs processing for detecting faces from the input video data, and outputs the detected face information and the video data to the tracking processing unit A1006. The processing then proceeds to step S203.

In step S203, the tracking processing unit A1006 selects a tracking target from among the plurality of pieces of input face information to perform tracking processing. The tracking processing unit A1006 outputs coordinate information about all the tracking targets to the history information holding unit A1007 as a tracking processing result. The processing then proceeds to step S204.

In step S204, the tracking processing unit A1006 determines whether the tracking processing is successful. If the tracking processing is successful as a result of this determination (YES in step S204), the processing proceeds to step S205. On the other hand, if the tracking processing is unsuccessful (NO in step S204), the processing proceeds to step S212.

In step S205, the history information holding unit A1007 holds all the input tracking processing results as the history information to output the history information to the movement direction calculation unit A1008. The processing then proceeds to step S206.

In step S206, the movement direction calculation unit A1008 calculates movement directions of all the tracking targets based on the input history information about the tracking processing results to output the movement directions to the field-of-view operation calculation unit A1009.

The processing then proceeds to step S207.

In step S207, the field-of-view operation calculation unit A1009 calculates field-of-view operation information based on the input movement directions and the tracking processing results of all the tracking targets to output the field-of-view operation information to the change necessity determination unit A1010. The processing then proceeds to step S208.

In step S208, the change necessity determination unit A1010 determines whether a target below the detectable size exists as a result of performing the wide-angle zoom operation based on the input field-of-view operation information and the tracking processing results. If the wide-angle zoom operation is not performed or no target below the detectable size exists even when the wide-angle zoom operation is performed as a result of the determination (NO in step S208), the processing proceeds to step S211. On the other hand, if a target below the detectable size exists as a result of performing the wide-angle zoom operation (YES in step S208), the processing proceeds to step S209.

In step S209, the change necessity determination unit A1010 determines whether the number of tracking targets that have moved in the direction which follows the wide-angle zoom operation is half or more of all the targets. If the number of tracking targets is half or more of all the tracking targets as a result of this determination (YES in step S209), the processing proceeds to step S211. On the other hand, if the number of tracking targets is less than half of all the tracking targets (NO in step S209), the processing proceeds to step S210.

In step S210, the field-of-view operation recalculation unit A1011 recalculates the field-of-view operation information based on a tracking processing result of a target subject to recalculation to output the recalculated field-of-view operation information to the field-of-view operation unit A1012. The processing then proceeds to step S211.

In step S211, the field-of-view operation unit A1012 generates a PTZ control instruction based on the input field-of-view operation information to output the PTZ control instruction to the PTZ driving device A1002. This causes the PTZ driving device A1002 to perform PTZ driving, which changes the field-of-view of imaging in the video acquisition device A1001. The processing then proceeds to step S212.

In step S212, the video output unit A1013 outputs the input video image to the monitor device A1014. The processing then proceeds to step S213.

In step S213, the CPU 151 determines whether an instruction to stop the automatic imaging processing is received from the input unit 156 via a user's operation. If no instruction to stop the automatic imaging processing is received as a result of this determination (NO in step S213), the processing returns to step S201. On the other hand, if an instruction to stop the automatic imaging processing is received (YES in step S213), the automatic imaging processing illustrated in FIG. 2 ends.

According to the present embodiment described above, the imaging control apparatus A1003 is configured to determine whether the number of tracking targets that have moved in the direction which follows the wide-angle zoom operation is half or more of all the tracking targets if a target below the detectable size exists based on the field-of-view operation information calculated from the tracking processing results. The imaging control apparatus A1003 is configured to, if the number of tracking targets is less than half of all the tracking targets, recalculate the field-of-view operation information except for the tracking targets that have moved. This configuration allows the imaging control apparatus A1003 to perform an appropriate field-of-view operation based on motion conditions of the targets in the screen when, for example, some of the tracking targets move out of the screen to intentionally avoid being imaged.

### Second Embodiment

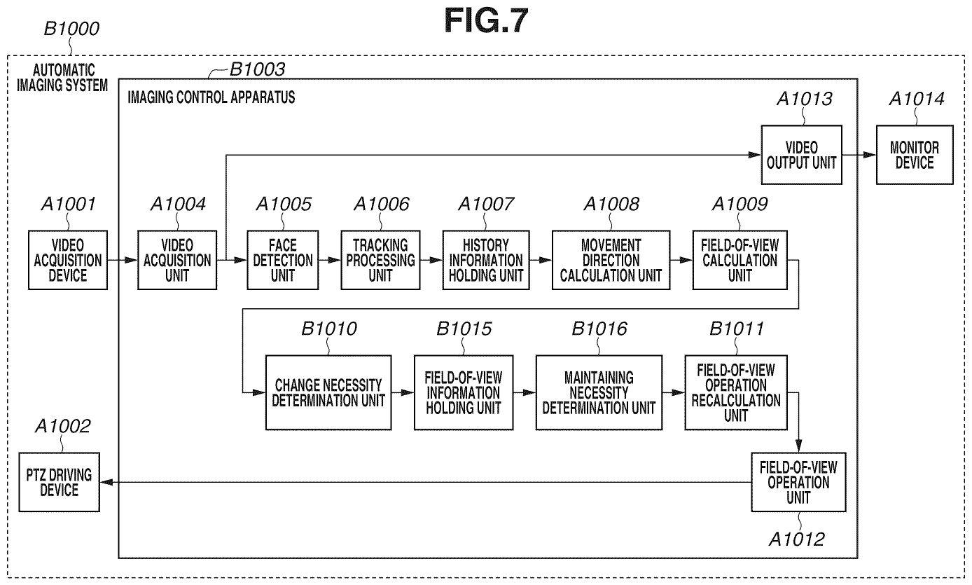

An example will be described of a configuration of an automatic imaging system according to a second embodiment with reference to FIG. 7. FIG. 7 is a block diagram illustrating an example of a functional configuration of the automatic imaging system including an imaging control apparatus according to the present embodiment. The hardware configuration of an imaging control apparatus B1003 according to the present embodiment is similar to that in FIG. 12, and thus, the description thereof will be omitted.

An automatic imaging system B1000 performs tracking processing based on the video image acquired from the video acquisition device A1001, and a field-of-view operation using the PTZ driving device A1002 to prevent tracking targets from being outside the field-of-view, similarly to the first embodiment. At that time, if a target below a detectable size, which is undetectable, through a wide-angle zoom control exists, an appropriate field-of-view operation is performed based on conditions of the tracking targets in the screen. An imaging result is then displayed on the monitor device A1014.

The automatic imaging system B1000 includes the video acquisition device A1001, the PTZ driving device A1002, an imaging control apparatus B1003, and the monitor device A1014. The imaging control apparatus B1003 is connected to the video acquisition device A1001 and the PTZ driving device A1002 via a network. Further, the imaging control apparatus B1003 is connected to the monitor device A1014 via a video interface. The video acquisition device A1001, the PTZ driving device A1002, and the monitor device A1014 are the same as those in the first embodiment.

The imaging control apparatus B1003 performs the tracking processing based on a plurality of pieces of face information detected using input video data. At this time, the imaging control apparatus B1003 determines whether a tracking target is below the detectable size, which is undetectable, and is excluded from the tracking targets through the field-of-view operation calculated to keep the tracking targets in the field-of-view. If a tracking target is excluded from the tracking targets, an appropriate field-of-view operation based on the directions in which the tracking targets move in the screen. Further, in the present embodiment, if a tracking target below the detectable size, which is undetectable, exists, maintaining the zoom magnification for a predetermined time facilitates redetecting a human body excluded from the tracking targets once as one of the tracking targets.

The imaging control apparatus B1003 includes the video acquisition unit A1004, the face detection unit A1005, the tracking processing unit A1006, the history information holding unit A1007, the movement direction calculation unit A1008, and the field-of-view operation calculation unit A1009. Further, the imaging control apparatus B1003 includes a change necessity determination unit B1010, a field-of-view operation recalculation unit B1011, the field-of-view operation unit A1012, the video output unit A1013, a field-of-view information holding unit B1015, and a maintaining necessity determination unit B1016. The present embodiment is different from the first embodiment in the change necessity determination unit B1010, the field-of-view operation recalculation unit B1011, the field-of-view information holding unit B1015, and the maintaining necessity determination unit B1016. In the following, the description of the configurations similar to those in the first embodiment will be omitted and configurations different from the first embodiment will be described.

The change necessity determination unit B1010 determines whether a change in field-of-view operation information is necessary based on the field-of-view operation information and tracking processing results input from the field-of-view operation calculation unit A1009. The determination method is similar to that performed by the change necessity determination unit A1010 illustrated in FIG. 1, and thus, the description will be omitted. In the present embodiment, the change necessity determination unit B1010 outputs to the field-of-view information holding unit B1015 a result of determining whether a change in field-of-view operation information is necessary and the reason for that determination, and input field-of-view operation information and tracking processing results.

The field-of-view information holding unit B1015 maintains a zoom magnification based on the input field-of-view operation information if the result of determination as to whether a change in the field-of-view operation information is necessary and the reason for this determination, the field-of-view operation information and that reason being input from the change necessity determination unit B1010, for example, correspond to the case illustrated in FIG. 3. In other words, if a change in the field-of-view operation information is determined to be unnecessary for the reason that the number of tracking targets that have moved in the direction which follows the wide-angle zoom operation is half or more of all the tracking targets, the zoom magnification based on the input field-of-view operation information as illustrated in FIG. 5 is maintained. The field-of-view information holding unit B1015 outputs to the maintaining necessity determination unit B1016 information about the maintained zoom magnification, the input result of determination as to whether a change in the field-of-view operation information is necessary and the input determination reason, and the field-of-view operation information and the tracking processing results.

The maintaining necessity determination unit B1016 determines whether the zoom magnification continues to be maintained based on the result of determination as to whether a change in the field-of-view operation information is necessary and the determination reason, the field-of-view operation information and the determination reason being input from the field-of-view information holding unit B1015, and the information about the zoom magnification. This determination processing will now be described with reference to a specific example.

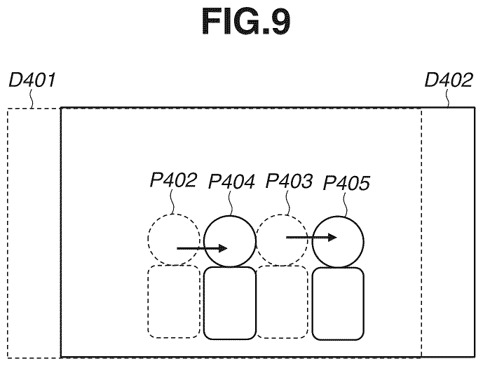

FIG. 9 is a diagram for describing a state in which a change in the field-of-view operation information is determined to be unnecessary and the zoom magnification is maintained. FIG. 9 illustrates a current field of view D401 and a field of view D402 calculated from the tracking processing results. Further, FIG. 9 illustrates human bodies P402, P403, P404, and P405, and the human bodies P404 and P405 indicate destinations to which the human bodies P402 and P403 move from the preceding frame, respectively. In the present embodiment, the maintaining necessity determination unit B1016 determines whether the zoom magnification continues to be maintained based on the time that has elapsed since the start of maintaining the zoom magnification or whether a new tracking target appears in the screen in a case where the zoom magnification is maintained as illustrated in FIG. 9. If a predetermined time has elapsed since the start of maintaining the zoom magnification, the maintained zoom magnification is deleted. If the predetermined time has not elapsed, the zoom magnification continues to be maintained.

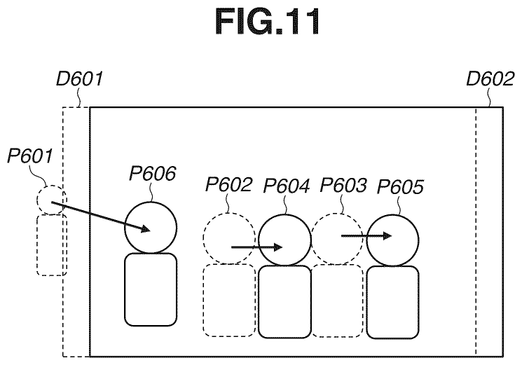

Further, the maintaining necessity determination unit B1016 also deletes information about the zoom magnification if a new tracking target appears in the screen as an example illustrated in FIG. 11. FIG. 11 illustrates a current field of view D601 and a field of view D602 calculated from the tracking processing results. FIG. 11 illustrates human bodies P601, P602, P603, P604, P605, and P606, and the human bodies P604, P605, and P606 indicate destinations to which the human bodies P602, P603 and P601 move from the preceding frame, respectively. In the example illustrated in FIG. 11, the human body P606 newly appears on the screen and becomes a new tracking target. In such a case, the information about the zoom magnification is also deleted. The maintaining necessity determination unit B1016 outputs to the field-of-view operation recalculation unit B1011 the information about the zoom magnification, the input result of determination as to whether a change in the field-of-view operation information is necessary and the input determination reason, and the field-of-view operation information and the tracking processing results.

The field-of-view operation recalculation unit B1011 recalculates the field-of-view operation information using the information input from the maintaining necessity determination unit B1016. Recalculation when no zoom magnification is maintained is similar to that of the field-of-view operation recalculation unit A1011 illustrated in FIG. 1, and thus, the description thereof will be omitted. Recalculation will now be described of field-of-view operation information when the zoom magnification is maintained.

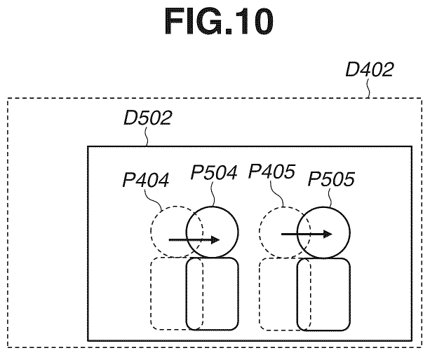

FIG. 10 is a diagram for describing a method of recalculating the field-of-view operation information after the predetermined time has elapsed since the start of maintaining the zoom magnification. FIG. 10 illustrates a video image in which a field of view D502 is recalculated using the field of view D402 illustrated in FIG. 9, and illustrates human bodies P504 and P505, both of which indicate destinations to which P404 and P405 move, respectively. Further, the field-of-view operation information is also recalculated when a new tracking target appears on the screen as the example illustrated in FIG. 11. The field-of-view operation recalculation unit B1011 outputs the recalculated field-of-view operation information to the field-of-view operation unit A1012.

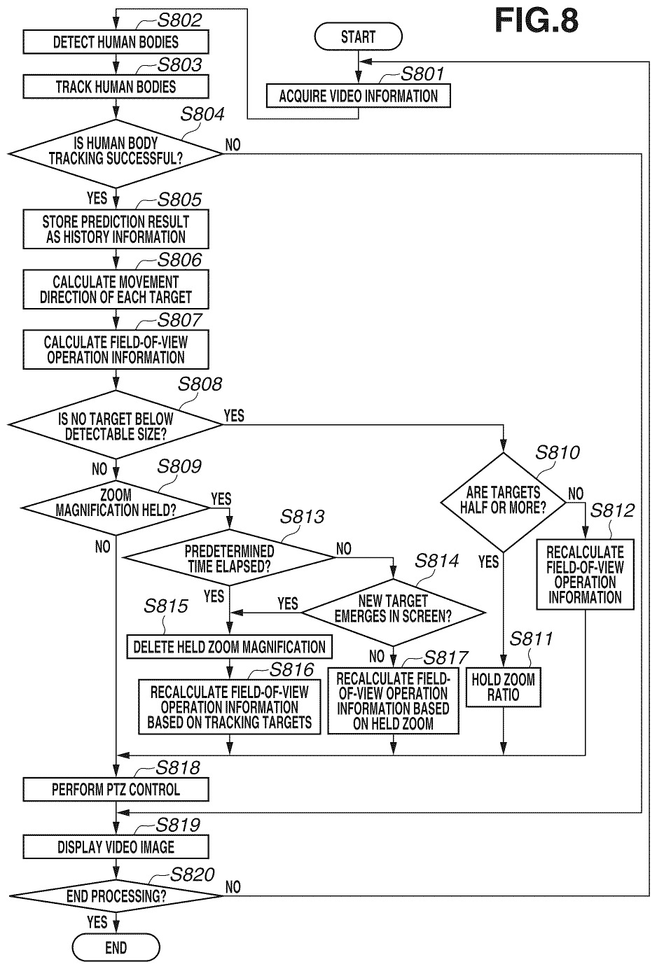

FIG. 8 is a flowchart illustrating an example of a processing procedure for performing a field-of-view operation by the imaging control apparatus B1003 in the automatic imaging system B1000. Each operation in FIG. 8 is performed by the CPU 151 loading a program stored in the ROM 152 into the RAM 153 to execute the program. The processing illustrated in FIG. 8 starts upon the automatic imaging system B1000 being started by the input unit 156 via a user's operation.

In step S801, the video acquisition unit A1004 acquires video data from the video acquisition device A1001 to output the video data to the face detection unit A1005 and the video output unit A1013. The processing then proceeds to step S802.

In step S802, the face detection unit A1005 performs processing for detecting a face from the input video data to output the detected face information and the video data to the tracking processing unit A1006. The processing then proceeds to step S803.

In step S803, the tracking processing unit A1006 selects a tracking target from among the plurality of pieces of input face information to perform tracking processing. The tracking processing unit A1006 then outputs to the history information holding unit A1007 coordinate information about all the tracking targets as a tracking processing result. The processing then proceeds to step S804.

In step S804, the tracking processing unit A1006 determines whether the tracking processing is successful. If the tracking processing is successful as a result of this determination (YES in step S804), the processing proceeds to step S805. On the other hand, if the tracking processing is unsuccessful (NO in step S804), the processing proceeds to step S819.

In step S805, the history information holding unit A1007 holds all the input tracking processing results as history information, and outputs the history information to the movement direction calculation unit A1008. The processing then proceeds to step S806.

In step S806, the movement direction calculation unit A1008 calculates movement directions of all the tracking targets based on the input history information about the tracking processing results to output the calculated movement directions to the field-of-view operation calculation unit A1009.

The processing then proceeds to step S807.

In step S807, the field-of-view operation calculation unit A1009 calculates field-of-view operation information based on the input movement directions and the tracking processing results of all the tracking targets to output the calculated field-of-view operation information to the change necessity determination unit A1010. The processing then proceeds to step S808.

In step S808, the change necessity determination unit B1010 determines whether a target below the detectable size appears as a result of performing the wide-angle zoom operation based on the input field-of-view operation information and the tracking processing results. If the wide-angle zoom operation is not performed or no target below the detectable size appears even when the wide-angle zoom operation is performed as a result of this determination (NO in step S808), the processing proceeds to step S809. On the other hand, if a target below the detectable size appears as a result of performing the wide-angle zoom operation (YES in step S808), the processing proceeds to step S810.

In step S809, the maintaining necessity determination unit B1016 determines whether the information about the zoom magnification is held. If the information about the zoom magnification is held as a result of this determination (YES in step S809), the processing proceeds to step S813. On the other hand, if the information about the zoom magnification is not held (NO in step S809), the processing proceeds to step S818.

In step S810, the change necessity determination unit B1010 determines whether the number of tracking targets that have moved in the direction which follows the wide-angle zoom operation is half or more of all the tracking targets. If the number of tracking targets is half or more of all the tracking targets as a result of this determination (YES in step S810), the processing proceeds to step S811. On the other hand, if the number of tracking targets is less than half of all the tracking targets (NO in step S810), the processing proceeds to step S812.

In step S811, the field-of-view information holding unit B1015 holds information about the zoom magnification in the calculated field-of-view operation information. The processing then proceeds to step S818.

In step S812, the field-of-view operation recalculation unit B1011 recalculates the field-of-view operation information based on an input tracking result of a target subject to recalculation to output the recalculated field-of-view operation information to the field-of-view operation unit A1012. The processing then proceeds to step S818.

In step S813, the maintaining necessity determination unit B1016 determines whether the predetermined time has elapsed since the start of holding information about the zoom magnification. If the predetermined time has elapsed as a result of this determination (YES in step S813), the processing proceeds to step S815. On the other hand, if the predetermined time has not elapsed (NO in step S813), the processing proceeds to step S814.

In step S814, the maintaining necessity determination unit B1016 determines whether a new tracking target appears on the screen. If a new tracking target appears in the screen as a result of this determination (YES in step S814), the processing proceeds to step S815. On the other hand, if no new tracking target appears in the screen (NO in step S814), the processing proceeds to step S817.

In step S815, the field-of-view operation recalculation unit B1011 deletes the information about the zoom magnification held by the field-of-view information holding unit B1015. The processing then proceeds to step S816.

In step S816, the field-of-view operation recalculation unit B1011 recalculates the field-of-view operation information based on the tracking processing results of the tracking targets in the screen. The processing then proceeds to step S818.

On the other hand, in step S817, the field-of-view operation recalculation unit B1011 recalculates the field-of-view operation information based on the information about the zoom magnification held by the field-of-view information holding unit B1015 and the tracking processing results of the tracking targets in the screen. The processing then proceeds to step S818.

In step S818, the field-of-view operation unit A1012 generates a PTZ control instruction based on the input field-of-view operation information to output the PTZ control instruction to the PTZ driving device A1002. This causes the PTZ driving device A1002 to perform PTZ driving, which changes the field-of-view of imaging by the video acquisition device A1001. The processing then proceeds to step S819.

In step S819, the video output unit A1013 outputs the input video image to the monitor device A1014. The processing then proceeds to step S820.

In step S820, the CPU 151 determines whether an instruction to stop the automatic imaging processing is received from the input unit 156 via a user's operation. If no instruction to stop the automatic imaging processing is received as a result of this determination (NO in step S820), the processing returns to step S801. On the other hand, if an instruction to stop the automatic imaging processing is received (YES in step S820), the automatic imaging processing illustrated in FIG. 8 ends.

According to the present embodiment described above, if a tracking target below the detectable size exists and the number of tracking targets that have moved in the direction which follows the wide-angle zoom operation is half or more of all the tracking targets, the information about the zoom magnification is held. Further, a PTZ control instruction is generated based on the maintained zoom magnification until the predetermined time has elapsed since the start of holding the information about the zoom magnification, or until a new tracking target appears. This configuration allows a field-of-view operation to be performed to facilitate redetecting in the screen a target that is below the detectable size and is excluded from the tracking targets once.

### Other Embodiments

In each of the above-described embodiments, a human body has been described as an example of the tracking target, but the tracking target can also apply to other objects, such as animals. In this case, similar effects can be achieved by recalculating image operation information when the number of objects that have moved in a direction which follows a wide-angle zoom operation is less than half of the number of all objects.

In the above-described first and second embodiments, the necessity of changing field-of-view operation information is determined when a tracking target below a detectable size exists based on the field-of-view operation information calculated from tracking processing results. At this time, control may also be performed of prioritizing the orientation of the majority of human faces on the screen. Specifically, field-of-view operation information may be recalculated when a tracking target below a detectable size exists based on the field-of-view operation information calculated from tracking processing results and the number of human bodies whose faces are oriented in the same direction is less than half of all the human bodies.

Alternatively, control may be performed of prioritizing human bodies speaking in the screen. Specifically, field-of-view operation information may be recalculated when a tracking target below a detectable size exists based on the field-of-view operation information calculated from tracking processing results and the number of speaking human bodies is less than half of all the human bodies. The presence or absence of speech by human bodies as tracking targets may be determined based on mouth movement or audio data.

Further, in the above-described first and second embodiments, field-of-view operation information may be recalculated based on settings configured via a user's operation when a determination is made whether a change in the field-of-view operation information is necessary. Further, a video image in which tracking processing results are superimposed on video data may be displayed on the monitor device A1014 if a tracking target below a detectable size exists based on field-of-view operation information calculated from the tracking processing results. At this time, the superimposed display may further be performed so that the tracking target below the detectable size can be visually distinguished from the other tracking targets.

The disclosures of the present embodiments include the following configurations, method, and program.

### Configuration 1

An imaging control apparatus comprising:
a detection unit configured to detect a plurality of objects from a video image captured by an imaging unit;
a control unit configured to control an imaging range of the imaging unit so as to image all objects set as tracking targets out of the plurality of objects; and
a recalculation unit configured to recalculate the imaging range based on history information about the objects set as the tracking targets in a case where an object having a size undetectable by the detection unit exists among the plurality of objects in the imaging range,
wherein the control unit controls the imaging unit so that the imaging range is set to the recalculated imaging range in a case where the imaging range is recalculated by the recalculation unit.

### Configuration 2

The imaging control apparatus according to the configuration 1,
wherein the detection unit further acquires movement directions of the plurality of detected objects, and
wherein, in a case where the object having the size undetectable by the detection unit exists among the plurality of objects in the imaging range controlled by the control unit and the number of objects that have moved in a direction for enlarging the imaging range is less than a predetermined number, the recalculation unit recalculates the imaging range set by the control unit so that the object having the undetectable size is detected.

### Configuration 3

The imaging control apparatus according to the configuration 1,
wherein the detection unit further acquires orientations of the detected objects, and
wherein, in a case where the object having the size undetectable by the detection unit exists among the plurality of objects in the imaging range controlled by the control unit and the number of objects having the same orientation among the plurality of objects is less than a predetermined number, the recalculation unit recalculates the imaging range set by the control unit so that the object having the undetectable size is detected.

### Configuration 4

The imaging control apparatus according to the configuration 1,
wherein the plurality of objects is plurality of human bodies,
wherein the detection unit further acquires a presence or absence of speech in the detected human bodies, and
wherein, in a case where the object having the size undetectable by the detection unit exists among the plurality of objects in the imaging range controlled by the control unit and the number of speaking human bodies among the plurality of human bodies is less than a predetermined number, the recalculation unit recalculates the imaging range set by the control unit so that the object having the undetectable size is detected.

### Configuration 5

The imaging control apparatus according to the configuration 1, further comprising an input unit configured to receive an operation by a user,
wherein the recalculation unit recalculates the imaging range based on information input from the input unit.

### Configuration 6

The imaging control apparatus according to any one of the configurations 1 to 5, further comprising a holding unit configured to hold information about a zoom magnification of the imaging range set by the control unit based on conditions of the plurality of detected objects in a case where the object having the size undetectable by the detection unit exists among the plurality of objects in the imaging range controlled by the control unit,
wherein the recalculation unit recalculates the imaging range using the held information about the zoom magnification while the information about the zoom magnification is being held by the holding unit.

### Configuration 7

The imaging control apparatus according to the configuration 6, wherein the holding unit deletes the held information about the zoom magnification in a case where a predetermined time has elapsed since start of holding the information about the zoom magnification.

### Configuration 8

The imaging control apparatus according to the configuration 6 or 7, wherein the holding unit deletes the held information about the zoom magnification in a case where a new object is detected by the detection unit.

### Configuration 9

The imaging control apparatus according to any one of the configurations 6 to 8, wherein in a case where the information about the zoom magnification held by the holding unit is deleted, the control unit controls the imaging unit so that the imaging range is set based on positions and sizes of the plurality of objects detected by the detection unit.

### Configuration 10

The imaging control apparatus according to any one of the configurations 1 to 9, further comprising an output unit configured to display information about the objects detected by the detection unit on a display unit with the detected information about the objects superimposed on the video image captured by the imaging unit,
wherein in a case where the object having the size undetectable by the detection unit exists, the output unit displays the object having the undetectable size distinguishably from another detected object.

### Configuration 11

The imaging control apparatus according to any one of the configurations 1 to 10,
wherein the tracking targets are selected based on coordinate information about the plurality of objects and preset composition information, and
wherein the composition information includes a layout, a size, a number, and a positional relationship of the objects.

### Configuration 12

The imaging control apparatus according to any one of the configurations 1 to 10, wherein the tracking targets are objects selected by the user from among the plurality of objects.

### Method

A control method comprising:
detecting a plurality of objects from a video image captured by an imaging unit;
controlling an imaging range of the imaging unit so as to image all objects set as tracking targets out of the plurality of objects; and
recalculating the imaging range based on history information about the objects set as the tracking targets in a case where an object having a size undetectable by the detecting exists among the plurality of objects in the imaging range,
wherein the controlling includes controlling the imaging unit so that the imaging range is set to the recalculated imaging range in a case where the imaging range is recalculated by the recalculation.

### Program

A program causing a computer to execute:
detecting a plurality of objects from a video image captured by an imaging unit;
controlling an imaging range of the imaging unit so as to image all objects set as tracking targets out of the plurality of objects; and
recalculating the imaging range based on history information about the objects set as the tracking targets in a case where an object having a size undetectable by the detecting exists among the plurality of objects in the imaging range,
wherein the controlling includes controlling the imaging unit so that the imaging range is set to the recalculated imaging range in a case where the imaging range is recalculated by the recalculation.

According to the present disclosure, an appropriate field-of-view operation can be performed based on a condition when a plurality of tracking targets is automatically tracked.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-008719, filed Jan. 21, 2025, which is hereby incorporated by reference herein in its entirety.

What is claimed is:

1. A control apparatus comprising:
one or more memories storing instructions; and
one or more processors executing the instructions to:
detect a plurality of objects from a video image captured by an imaging device;
determine an imaging range of the imaging device based on history information about objects set as tracking targets to image all the objects set as the tracking targets out of the plurality of objects; and
control the imaging device so that the imaging range is set to the determined imaging range.

2. The control apparatus according to claim 1, wherein the imaging range is determined based on the history information about the objects set as the tracking targets in a case where an object having an undetectable size in the imaging range exists among the plurality of objects.

3. The control apparatus according to claim 2,
wherein the one or more processors further execute the instructions to obtain movement directions of the plurality of objects, and
wherein the imaging range is determined so that the object having the undetectable size is detected in a case where the number of objects that have moved in a direction for enlarging the imaging range is less than a predetermined number.

4. The control apparatus according to claim 2,
wherein the one or more processors further execute the instructions to obtain orientations of the plurality of objects, and
wherein the imaging range is determined so that the object having the undetectable size is detected in a case where the number of objects oriented in the same direction among the plurality of objects is less than a predetermined number.

5. The control apparatus according to claim 2,
wherein the plurality of objects are a plurality of human bodies,
wherein the one or more processors further execute the instructions to obtain a presence or absence of speech in the detected human bodies, and
wherein the imaging range is determined so that the object having the undetectable size is detected in a case where the number of speaking human bodies among the plurality of human bodies is less than a predetermined number.

6. The control apparatus according to claim 1,
wherein the one or more processors further execute the instructions to receive an operation by a user, and
wherein the imaging range is determined based on information input by the user's operation.

7. The control apparatus according to claim 2,
wherein the one or more processors further execute the instructions to cause the one or more memories to store information about a zoom magnification of the imaging range set based on conditions of the plurality of objects, and
wherein the imaging range is determined using the zoom magnification while the information about the zoom magnification is being stored.

8. The control apparatus according to claim 7, wherein the stored information about the zoom magnification is deleted after a predetermined time has elapsed since the storage of the information.

9. The control apparatus according to claim 7, wherein the stored information about the zoom magnification is deleted in a case where a new object is detected.

10. The control apparatus according to claim 7, wherein the imaging device is controlled so that the imaging range is set based on positions and sizes of the plurality of detected objects in a case where the information about the zoom magnification is deleted.

11. The control apparatus according to claim 1,
wherein the one or more processors further execute the instructions to cause a display device to display information about the detected objects with the information about the detected object superimposed on the video image, and
wherein in a case where an object having an undetectable size exists in the imaging range, the object having the undetectable size and another detected object are displayed distinguishably from each other.

12. The control apparatus according to claim 1,
wherein the tracking targets are selected based on coordinate information about the plurality of objects and preset composition information, and
wherein the composition information includes a layout, a size, a number, and a positional relationship of the objects.

13. The control apparatus according to claim 1, wherein the tracking targets are objects selected by the user from among the plurality of objects.

14. A control method comprising:
detecting a plurality of objects from a video image captured by an imaging device;
determining an imaging range of the imaging device based on history information about objects set as tracking targets to image all the objects set as the tracking targets among the plurality of objects; and
controlling the imaging device so that the imaging range is set to the determined imaging range.

15. The control method according to claim 14, wherein the imaging range is determined based on the history information about the objects set as the tracking targets in a case where an object having an undetectable size exists in the imaging range among the plurality of objects.

16. A non-transitory computer-readable storage medium storing a program that causes a computer to execute a control method, the control method comprising:
detecting a plurality of objects from a video image captured by an imaging device;
determining an imaging range of the imaging device based on history information about objects set as tracking targets to image all the objects set as the tracking targets among the plurality of objects; and
controlling the imaging device so that the imaging range is set to the determined imaging range.

17. The non-transitory computer-readable storage medium according to claim 16, wherein the imaging range is determined based on the history information about the objects set as the tracking targets in a case where an object having an undetectable size exists in the imaging range among the plurality of objects.
